(19) United States
(12) Patent Application Publication
(10) Pub. No.: US 2023/0347378 A1
(43) Pub. Date: Nov. 2, 2023

(54) COMPOSITIONS AND METHODS FOR COATING A SUBSTRATE

(71) Applicant: Ecolab USA Inc., St. Paul, MN (US)

(72) Inventor: Alessandra GERLI, Leiden (NL)

(73) Assignee: Ecolab USA Inc., St. Paul, MN (US)

(21) Appl. No.: 18/192,499

(22) Filed: Mar. 29, 2023

Related U.S. Application Data
(60) Provisional application No. 63/326,657, filed on Apr. 1, 2022.

(51) Int. Cl. B05D 1/02; B05D 3/02; B05D 1/38

(52) U.S. Cl. CPC B05D 1/38; B05D 1/02; B05D 3/02; B05D 2203/22; B05D 2401/40; B05D 2518/00

(57) ABSTRACT

The disclosure provides methods and compositions for coating substrates. A method of coating a substrate may include applying a formulation having a metal cation to a surface of the substrate to form a treated substrate, adding a solution having a biopolymer to the treated substrate, and allowing the biopolymer and the metal cation to react to form a coated substrate. The formulation may be applied to the substrate before the solution is added. A composition may include a reaction product of a biopolymer and a metal cation. The reaction product may be disposed on a coated substrate and the coated substrate may comprise a fibrous material.

### TECHNICAL FIELD

The present disclosure generally relates to compositions and methods for coating a substrate. More particularly, the disclosure relates to compositions comprising a metal cation and a biopolymer and methods for coating substrates using a metal cation and a biopolymer.

### BACKGROUND

Paper and paperboard used for food packaging are commonly coated with petroleum-based plastic materials, such as polyethylene, waxes and/or fluorochemicals. Coatings having these materials form a barrier to reduce the flow of substances, such as grease, water vapor, gas, and/or liquid through the paper and/or paperboard. Although plastics can provide barrier properties to packaging materials, they have a negative environmental impact. Per- and polyfluoroalkyl substances (PFAS) are also used to impart oil and grease resistance to paper but there is interest in removing PFAS from products due to toxicity and low rates of biodegradation.

### BRIEF SUMMARY

The disclosure provides methods and compositions for forming a biodegradable coating on a substrate. The coating acts as a barrier against the movement of liquids, gases, or semi-solids through the substrate.

In some embodiments, a method of coating a substrate comprises applying a formulation comprising a metal cation to a surface of the substrate to form a treated substrate, adding a solution comprising a biopolymer to the treated substrate, and allowing the biopolymer and the metal cation to react to form a coated substrate. The formulation comprising the metal cation is applied to the substrate before the solution comprising the biopolymer is added. In some embodiments, the solution comprising the biopolymer is not added to the substrate before the formulation comprising the metal cation.

In some embodiments, the substrate and/or the coated substrate comprises a fibrous material. In some embodiments, the fibrous material comprises about 9 wt. % or less of a filler. In certain embodiments, the fibrous material is a kraft paper or a molded paper product. In some embodiments, the substrate and/or the coated substrate excludes a filler.

In some embodiments, the metal cation is water-soluble. In some embodiments, the formulation comprising the metal cation forms a first layer on a surface of the treated substrate. In certain embodiments, the first layer covers about 75% to about 100% of the surface.

In some embodiments, the formulation comprising the metal cation further comprises starch. In certain embodiments, the solution comprising the biopolymer further comprises starch.

In some embodiments, the method further comprises drying the treated substrate before adding the solution comprising the biopolymer. In some embodiments, the method further comprises drying the coated substrate after adding the solution comprising the biopolymer.

In certain embodiments, the formulation comprising the metal cation is sprayed or printed onto the surface of the substrate. In some embodiments, the formulation comprising the metal cation is applied to the substrate at a size press. In some embodiments, the formulation comprising the metal cation is applied in a wet end of a papermaking machine. In certain embodiments, the solution comprising the biopolymer is sprayed or printed onto the surface of the treated substrate. In some embodiments, the solution comprising the biopolymer is added to the treated substrate at a size press.

In some embodiments, the biopolymer comprises a carboxylic acid group. In some embodiments, the metal cation is a divalent metal cation. In certain embodiments, the metal cation is selected from the group consisting of calcium, magnesium, zinc, barium, copper, strontium, manganese, iron, nickel, cobalt, tin, cadmium, lead, and any combination thereof.

In some embodiments, the biopolymer is selected from the group consisting of an alginate, a pectin, a gellan gum, and any combination thereof. In some embodiments, the biopolymer comprises sodium alginate. In certain embodiments, the biopolymer is crosslinked with the metal cation.

In some embodiments, a salt comprises the metal cation. In certain embodiments, the salt is selected from the group consisting of calcium chloride, calcium bromide, calcium nitrate, calcium acetate, calcium propionate, calcium lactate, calcium gluconate, magnesium chloride, magnesium bromide, magnesium nitrate, magnesium acetate, and any combination thereof. In some embodiments, the salt is water-soluble.

In some embodiments, the solution comprises from about 0.05 wt. % to about 20 wt. % of the biopolymer. In some embodiments, the solution and/or the formulation comprises from about 0.1 wt. % to about 30 wt. % of the starch. In certain embodiments, the formulation comprises from about 0.2 wt. % to about 17 wt. % of the metal cation.

In some embodiments, the treated and/or coated substrate comprises from about 0.01 wt. % to about 2.5 wt. % of the metal cation. In some embodiments, the treated and/or coated substrate comprises from about 0.01 g/m² to about 3 g/m² of the metal cation. In certain embodiments, the coated substrate comprises from about 0.01 wt. % to about 12 wt. % of the biopolymer. In some embodiments, the treated and/or coated substrate comprises from about 0.1 wt. % to about 18 wt. % of the starch.

The present disclosure also provides a coated substrate comprising a reaction product of a biopolymer and a metal cation. The reaction product is disposed on a surface of the coated substrate and the coated substrate is a fibrous material comprising 8 wt. % or less of a filler.

In some embodiments, the fibrous material is kraft paper.

In some embodiments, the biopolymer comprises a carboxylic acid group. In certain embodiments, the metal cation is a divalent metal cation. In some embodiments, the metal cation is selected from the group consisting of calcium, magnesium, zinc, barium, copper, strontium, manganese, iron, nickel, cobalt, tin, cadmium, lead, and any combination thereof.

In some embodiments, the biopolymer is selected from the group consisting of an alginate, a pectin, a gellan gum, and any combination thereof. In certain embodiments, the biopolymer comprises sodium alginate.

In some embodiments, the coated substrate further comprises starch.

In some embodiments, the coated substrate comprises from about 0.01 wt. % to about 2.5 wt. % of the metal cation. In certain embodiments, the coated substrate comprises from about 0.01 wt. % to about 12 wt. % of the biopolymer. In some embodiments, the coated substrate comprises from about 0.1 wt. % to about 18 wt. % of the starch.

In certain embodiments, the coated substrate has a kit value of at least about 5.

The present disclosure also provides a method of coating a substrate comprising applying a formulation comprising a metal cation to a surface of the substrate to form a treated substrate, contacting the formulation with a solution comprising a biopolymer, and allowing the biopolymer and the metal cation to react to form a coated substrate. The coated substrate comprises less than about 8 wt. % of the metal cation.

In some embodiments, the substrate comprises a fibrous material. In some embodiments, the substrate comprises paper or paper board. In certain embodiments, the substrate excludes a filler. In some embodiments, the substrate is a kraft paper sheet.

The present disclosure also provides a coated substrate comprising a reaction product of a biopolymer and a metal cation. The reaction product is disposed on a surface of the coated substrate and the coated substrate comprises less than about 8 wt. % of the metal cation.

In some embodiments, the coated substrate comprises a fibrous material. In some embodiments, the coated substrate comprises paper or paper board. In certain embodiments, the coated substrate excludes a filler. In some embodiments, the coated substrate is a kraft paper sheet.

Additionally, the present disclosure provides a coated substrate produced by the process of applying a formulation comprising a metal cation to a surface of a substrate to form a treated substrate, adding a solution comprising a biopolymer to the treated substrate, and allowing the biopolymer and the metal cation to react to form a coated substrate.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### DETAILED DESCRIPTION

The paper manufacturing process can be organized into different general sections. For example, one section includes the location where a pulp slurry is disposed as thin layer on a moving papermaking wire or forming fabric. Another section is commonly referred to as the “press section,” which is where the thin layer is pressed to remove additional water. Following that is the dryer section where the pressed layer moves through a series of heated rollers. At this point, the dry substrate can be rewetted by passing it through a size press and further dried by passing it through another set of heated rollers. Finally, the dried substrate passes through a paper finishing section, such as a calendaring section. The compositions and methods disclosed herein can be incorporated into or carried out in any of the foregoing sections.

The term “pulp slurry” means a mixture comprising a liquid medium, such as water, within which solids, such as fibers (for example cellulose fibers) and optionally fillers, are dispersed or suspended such that between about >99% to about 45% by mass of the slurry is liquid medium. The portion of the papermaking process prior to the press section where a liquid medium, such as water, comprises more than about 45% of the mass of the substrate is referred to as the “wet end.” Conversely, the term “dry end” refers to that portion of the papermaking process including and subsequent to the press section where a liquid medium, such as water, typically comprises less than about 45% of the mass of the substrate. The compositions and methods disclosed herein can be incorporated into or carried out in the “wet end” and/or “dry end” of the papermaking process.

The present disclosure provides a biodegradable coating that imparts desired barrier functionalities to paper and paperboard end-products, such as oil and grease resistance. Methods and compositions are provided herein that impart advanced barrier treatments to paper and paperboard that prevent penetration of oil, grease, oxygen, air and aqueous liquids into and/or through the paper or paperboard. The methods and compositions may be designed in such a way that the paper or paperboard end-product is capable of being recycled.

The coated paper packaging can be used to package food, for example. Accordingly, the composition benefits from using chemicals that have global regulatory food contact approval for direct or indirect contact with food additives.

In addition to providing a barrier to grease and oil, the coating compositions and methods disclosed herein also improve the heat-seal properties and water vapor transmission rate (WVTR) of a substrate.

As used herein, the term “fibrous material” refers to a type of substrate that contains at least 50 wt. % or more fibers. A fibrous material may be composed substantially of fibers or entirely of fibers. In some embodiments, the fibrous material may contain less than about 9 wt. % of filler. For example, in some embodiments, the fibrous material may contain less than about 8 wt. %, less than about 7 wt. %, less than about 6 wt. %, less than about 5 wt. %, less than about 4 wt. %, less than about 3 wt. %, less than about 2 wt. %, or less than about 1 wt. % of filler.

In the context of the fibrous material, the phrase, “may be composed substantially of fibers” refers to a fibrous material comprising at least about 95 wt. %, at least about 96 wt. %, at least about 97 wt. %, at least about 98 wt. %, or at least about 99 wt. % fibers.

A filler, also known as a particulate, is a metal ion particulate substance that is insoluble or sparingly soluble in water. Examples of filler include, but are not limited to, calcium carbonate, clay, titanium dioxide, talc and gypsum.

The fibrous material includes fibers that may be natural, synthetic, or a mixture of natural and synthetic fibers. Natural fibers from plants are often referred to as cellulosic fibers. Examples of cellulosic fibers are fibers derived from hardwood or softwood trees and non-wood fibers, such as fiber from grasses, cereal straws, corn stalks, bamboo, bagasse, flax, hemp, jute, kenaf, cotton, sisal, and abaca. Cereal straw can be wheat straw, rice straw, straws from larger groups of agricultural crops, such as barley, rye, rapeseed, sunflower, sorghum and combinations thereof. Synthetic fibers are fibers produced through extrusion or spinning. Examples of synthetic fibers are fiber glass, rayon, aramid, polyester, polyacrylic, polyethylene, polypropylene, polylactide and nylon fibers. In addition to virgin fibers, recycled fiber and fiber from waste, such as agriculture residues, may be included in the fibrous material.

Any pulping process, including mechanical, thermochemical, chemical and semi-chemical can be used to obtain cellulosic fibers from their respective sources. Chemical pulping can be performed using a kraft process, a sulfite process or soda processing. Cellulosic fiber can be unbleached, bleached or semi-bleached.

A fibrous material composed of kraft fibers is referred to as kraft paper. Kraft papers are the preferred material for any packaging material that requires strength properties. These papers generally do not contain any added fillers. On the contrary, paper grades for which strength is not a critical end-use requirement, such as printing and writing papers and certain specialty papers not intended to be used as packaging material, may contain more than about 10 wt. % of filler and typically more than about 20 wt. % of filler. The use of filler in these grades confers other desired properties, such as improved optical properties and printability while lowering the overall cost of paper.

A paper or paperboard comprising a fibrous material can be made using a standard papermaking process comprising forming an aqueous fibrous papermaking furnish, draining the furnish to form a wet sheet and drying the wet sheet to form a dry sheet (see, for example, Handbook for Pulp and Paper Technologists, 3rd Edition, by Gary A. Smook, Angus Wilde Publications Inc., (2002) and The Nalco Water Handbook (3rd Edition), by Daniel Flynn, McGraw Hill (2009)). The fibrous material can also be produced from pulp in a molding process that shapes it in various forms to be used, for example, as food service articles or containers for other commodities.

For the purposes of this disclosure, the fibrous material can be made into any paper grade that can benefit from enhanced barrier properties, such as release paper, glassine paper, machine-finished paper, machine-glazed paper, and vegetable parchment. The fibrous material can be used as a packaging material by itself or as a part of a multilayered construction for a variety of applications. Examples of applications include, but are not limited to, pet food liner bags, popcorn bag liners, liners to be used in food packaging items, such as pizza boxes, popcorn boxes/bags, butter wraps, bakery items, fast food wraps, cosmetic packaging and any packaging in need of barrier properties.

The starch material used in compositions, formulations and/or solutions in accordance with the present disclosure may comprise any starch, such as native starch or unmodified starch, amylose, amylopectin, starches containing various amount of amylose and amylopectin, a starch derivative, or mixture thereof. The starch may be non-ionic, anionic, cationic or amphoteric. The starch material may be selected from any source including, for instance, waxy corn, dent corn, wheat, tapioca, potato or waxy potato, rice, barley, pea, sago, sorghum, manioc, or mixtures thereof. Starch derivatives may include, for example, chemically modified, physically modified, and enzymatically modified starches.

Chemical modification may include any treatment of starch with a chemical that results in a modified starch. For example, the chemical modification may include, but is not limited to, one or more of depolymerization, oxidation, reduction, etherification, esterification, nitrification, defatting, hydrophobization, and the like. Examples of chemically modified starches are octenyl succinic anhydride-modifies starch, hydroxypropylated, acetylated starches, starch phosphate, and starch xanthate.

Physically modified starches are any starches that are physically treated to provide physically treated starches. For example, starches may be physically modified using the action of heat in a dry or non-dry medium, in the presence or absence of a chemical agent. Examples of physically modified starches are dextrins and maltodextrins.

Enzymatically modified starches may be formed from any starches that are enzymatically treated in any manner to provide enzymatically modified starches. For example, starches can be enzymatically treated using one or more enzymes such as an alpha-amylase, a lipase, a protease, a phosphorylase, or an oxidase.

Formulations and solutions of the compositions of the present disclosure may also comprise one or more additives conventionally applied to coating formulations to improve the coating’s properties. Examples of possible additives include plasticizers, sizing agents, surfactants, defoamers, dispersants, preservatives, biocidal agents, and any combination thereof. The amount of each of these compounds to be added, if any, may be determined in accordance with the standard practices and the desired properties of the particular coating composition being produced.

The term “plasticizer” refers to any compound or composition capable of imparting plasticity to the composition of the invention and flexibility to the barrier coating layers in use. Plasticizers can be selected from the group consisting of carbohydrates (mono-, di-, and oligo saccharides), polyols, synthetic polymers and/or oligomers, and mixtures of two or more thereof. Examples of carbohydrates are glucose, sucrose, dextrose, fructose, galactose, xylose, saccharose, maltose, and lactose. Examples of polyols are glycerol, sorbitol, mannitol, maltitol, xylitol, and erythritol. Examples of synthetic polymers and/or oligomers may include, for example, poly-alcohols, such as ethylene glycol, diethylene glycol and propylene glycols, polyethers such as polyethylene glycol, polyesters such as sorbates, isosorbides, glyceryl di- and tri-acetate.

The term “sizing agent” refers to any additive that provides water-holdout to a composition of the present disclosure. Conventional papermaking sizing agents include rosin-based products, alkenyl succinic anhydrides, alkyl ketene dimers, styrene-maleic anhydride copolymers, styrene-acrylate and methacrylate copolymers, polyurethanes, wax emulsions, wax dispersions or a mixture thereof. The selection and amount of sizing agent can depend on the specific end-use requirements of the paper and/or paperboard products and is within the purview of a person of ordinary skill in the art of papermaking.

The terms “wt. %”, “vol. %” or “mol. %” refer to a weight, volume, or molar percentage, respectively, of a component based on the total weight, volume, or moles of a composition, formulation, solution, mixture or the total weight of a fibrous substrate that include that component, as appropriate. The weight percent of a component in a composition, formulation, solution, mixture, etc., is determined by weighing the mass that remains after extracting the water or other solvent from the composition, formulation, solution, or mixture under mild conditions, e.g., upon drying in an oven at about 105° C. The weight percent of a component added to a fibrous substrate is determined based on the dry weight of the finished dried fibrous substrate.

Some embodiments of the present disclosure provide a method for coating a substrate. The method may include applying a formulation that includes a metal cation to a surface of the substrate to form a treated substrate and adding a solution comprising a biopolymer to the treated substrate. The resulting coated substrate may have a two-layer coating with significantly improved grease resistance properties.

The reaction of a metal cation, such as calcium, with a biopolymer, such as sodium alginate, is instantaneous and direct addition of the cation to the biopolymer leads to formation of gel clumps. However, the present inventor unexpectedly found that applying the metal cation to the surface of a substrate in a first step, followed by application of the biopolymer in a second step allowed the formation of a homogeneous film/coating on the coated substrate.

In some embodiments, the formulation is applied prior to, with, and/or after the solution. Also, the solution may be applied prior to, with, and/or after the formulation. For example, the formulation may be applied to the substrate and subsequently, the solution may be applied. As an additional example, the formulation may be applied before the solution and at the same time as the solution.

The substrate, treated substrate, and/or coated substrate may optionally be dried after any application of formulation and/or solution. For example, the formulation may be added to the substrate to form a treated substrate, the treated substrate may be dried, and then the solution may be added to the dried, treated substrate to form a coated substrate. The coated substrate may be dried after application of the solution. Drying can be performed by any technique without any limitation, such as drying with air, by convection, by contact, or by radiation, for example, by infrared radiation, and any combination thereof.

The substrate may be a fibrous material, which may optionally exclude or substantially exclude a filler. Examples of substrates include, but are not limited to, kraft paper and a molded paper product. The coated substrate may be capable of containing a food product or beverage product.

The fibrous material may comprise about 9 wt. % or less of a filler. In some embodiments, the fibrous material comprises less than about 8 wt. %, less than about 7 wt. %, less than about 6 wt. %, less than about 5 wt. %, less than about 4 wt. %, less than about 3 wt. %, less than about 2 wt. %, or less than about 1 wt. % of a filler. In some embodiments, the fibrous material comprises about 0.001 wt. % to about 9 wt. %, about 0.005 wt. % to about 9 wt. %, about 0.01 wt. % to about 8.5 wt. %, about 0.05 wt. % to about 8 wt. %, about 0.1 wt. % to about 7.5 wt. %, about 0.5 wt. % to about 7 wt. %, about 1 wt. % to about 6.5 wt. %, about 1.5 wt. % to about 6 wt. %, about 2 wt. % to about 5.5 wt. %, about 2.5 wt. % to about 5 wt. %, about 3 wt. % to about 4.5 wt. %, or about 3.5 wt. % to about 4 wt. % of a filler. In some embodiments, the fibrous material may comprise about 0.001 wt. %, about 0.005 wt. %, about 0.01 wt. %, about 0.05 wt. %, about 0.1 wt. %, about 0.5 wt. %, about 1 wt. %, about 1.5 wt. %, about 2 wt. %, about 2.5 wt. %, about 3 wt. %, about 3.5 wt. %, about 4 wt. %, about 4.5 wt. %, about 5 wt. %, about 5.5 wt. %, about 6 wt. %, about 6.5 wt. %, about 7 wt. %, about 7.5 wt. %, about 8 wt. %, about 8.5 wt. %, or about 9 wt. % of a filler.

The formulation added to the substrate comprises, consists of, or consists essentially of a metal cation and a liquid, such as water. In some embodiments, the formulation may also include starch. The metal cation may be water-soluble and/or a divalent metal cation and/or a multivalent metal cation. In some embodiments, the metal cation is selected from the group consisting of calcium, magnesium, zinc, barium, copper, strontium, manganese, iron, nickel, cobalt, tin, cadmium, lead, and any combination thereof.

In some embodiments, the formulation disclosed herein may have pH from about 3 to about 9. In some embodiments, the formulation may have pH from about 4 to about 9, about 5 to about 9, about 6 to about 9, or about 7 to about 9. The pH may be, for example, about 3, about 4, about 5, about 6, about 7, about 8, or about 9.

The formulation comprises at least 0.001 wt. % of the metal cation. In some embodiments, the formulation comprises less than about 20 wt. % of the metal cation. In some embodiments, the formulation comprises from about 0.001 wt. % to about 20 wt. %, about 0.005 wt. % to about 19 wt. %, about 0.01 wt. % to about 18 wt. %, about 0.2 wt. % to about 17 wt. %, about 0.3 wt. % to about 16 wt. %, about 0.4 wt. % to about 15 wt. %, or about 0.5 wt. % to about 14 wt. % of the metal cation. In some embodiments, the formulation comprises from about 0.1 wt. % to about 9 wt. %, about 0.2 wt. % to about 8 wt. %, or about 0.3 wt. % to about 7 wt. % of the metal cation. In some embodiments, the formulation comprises about 0.2 wt. % to about 0.5 wt. %, about 1 wt. % to about 3 wt. %, or about 4 wt. % to about 7 wt. % of the metal cation. In some embodiments, the formulation comprises about 0.5 wt. %, about 1 wt. %, about 1.5 wt. %, about 2 wt. %, about 2.5 wt. %, about 3 wt. %, about 3.5 wt. %, about 4 wt. %, about 4.5 wt. %, about 5 wt. %, about 5.5 wt. %, about 6 wt. %, about 6.5 wt. %, about 7 wt. %, about 7.5 wt. %, about 8 wt. %, about 8.5 wt. %, about 9 wt. %, about 9.5 wt. %, about 10 wt. %, about 10.5 wt. %, about 11 wt. %, about 11.5 wt. %, about 12 wt. %, about 12.5 wt. %, about 13 wt. %, about 13.5 wt. %, about 14 wt. %, about 14.5 wt. %, about 15 wt. %, about 15.5 wt. %, about 16 wt. %, about 16.5 wt. %, about 17 wt. %, about 17.5 wt. %, about 18 wt. %, about 18.5 wt. %, about 19 wt. %, about 19.5 wt. %, or about 20 wt. % of the metal cation.

In some embodiments, a salt comprising the metal cation may be added to the formulation. The salt may be selected from, for example, calcium chloride, calcium bromide, calcium nitrate, calcium acetate, calcium propionate, calcium lactate, calcium gluconate, magnesium chloride, magnesium bromide, magnesium nitrate, magnesium acetate, and any combination thereof. In some embodiments, the formulation comprises calcium chloride. The salt may be water-soluble.

The method of applying the formulation to the substrate is not particularly limited. In some embodiments, the formulation is sprayed onto a surface of the substrate. Alternatively or additionally, the formulation may be printed onto a surface of the substrate.

In some embodiments, the treated and/or coated substrate comprises from about 0.01 wt. % to about 2.5 wt. % of the metal cation. For example, the treated and/or coated substrate may comprise from about 0.1 wt. % to about 2 wt. %, about 0.1 wt. % to about 1.5 wt. %, about 0.1 wt. % to about 1 wt. %, or about 0.1 wt. % to about 0.5 wt. % of the metal cation.

The amount of metal cation added to the substrate may also be expressed in terms of grams per meters squared. For example, the treated and/or coated substrate may comprise from about 0.01 to about 3 g/m², 0.02 to about 3 g/m², from about 0.03 to about 2.5 g/m², from about 0.04 to about 2 g/m², or from about 0.04 to about 1.5 g/m² of the metal cation.

The formulation may be applied to the substrate, to a portion of the substrate, to at least one surface of the substrate, to multiple, both, or all surfaces of the substrate, etc. In some embodiments, the formulation comprising the metal cation may be applied to the substrate such that it forms a first layer on the surface of the treated substrate. In some embodiments, the first layer covers at least about 50%, at least about 55%, at least about 60%, at least about 65%, at least about 70%, at least about 75%, at least about 80%, at least about 85%, at least about 90%, at least about 95%, or at least about 100% of the surface of the treated substrate. In some embodiments, the first layer forms on an area of about 75% to about 100% of the surface. In some embodiments, the formulation is applied uniformly over the surface of the substrate while in other embodiments, the formulation is applied over a portion of the surface resulting in a first layer covering only a portion of the substrate.

The formulation may be applied to the substrate at the wet end, the press section, the dryer, and/or the calendaring section of the paper manufacturing process. The formulation may additionally or alternatively be applied before or after any of the foregoing sections of a paper manufacturing process, such as after the headbox in the wet end but before the press section. For example, the formulation may be applied at the wet end, after the pulp slurry is spread onto the moving papermaking wire or forming fabric. Alternatively, for example, the formulation may be applied at the size press.

The term “size press” means the part of the papermaking process where the dry paper is rewet by applying a liquid mixture that comprises starch and other additives, such as sizing agents and optical brightening agents. A more detailed description of a size press is described in the reference Handbook for Pulp and Paper Technologists, 3rd Edition, by Gary A. Smook, Angus Wilde Publications Inc., (2002), the contents of which are incorporated by reference into the present application. The size press can be a conventional metered size press or non-metered size press. Any size press design can be used, including, but not limited to, horizontal press, vertical press, gate roll size press and metering blade size press, rod, puddle type, or combinations thereof.

The formulation may be applied at the dry end at the dryer, and/or the calendaring section. The formulation may additionally or alternatively be applied at a coating unit. The coating unit can be any sort of coating device, such as blade coater, film coater, curtain coater, foam coater, spray coater, roll coater, rod coater and the like. The coating unit can be integrated with the paper machine (on-line coating) or be a separate coating unit (off-line coating). The formulation may be applied at a printing device, such as rotogravure, flexographic and/or inkjet printers, coating and corrugating equipment, and the like.

After the formulation comprising the metal cation is applied to the substrate to form a treated substrate, a solution comprising a biopolymer may be added to the treated substrate. In some embodiments, the treated substrate comprising the formulation may be dried prior to adding the solution. In some embodiments, the treated substrate comprising formulation may not be dried prior to adding the solution. After the solution is added to the treated substrate to form the coated substrate, the coated substrate may optionally be dried.

The solution comprises, consists of, or consists essentially of a biopolymer and a solvent, such as water. In some embodiments, the solution further includes a starch. The solution may comprise a so-called “water-soluble” biopolymer. In some embodiments, this term may imply that the bio-polymer is not fully water-soluble, but it is water dispersible to form colloidal dispersions, the viscosity of which increase with the concentration of the biopolymer.

The biopolymer may comprise a carboxylic acid group. Illustrative, non-limiting examples of biopolymers include an alginate, pectin, gellan gum, and any combination thereof. In some embodiments, the biopolymer comprises a “water-soluble” alginate, such as sodium alginate, potassium alginate, ammonium alginate, propylene glycol alginate and any combination thereof. Propylene glycol alginate is made by esterification of the carboxylic groups in alginic acid with propylene glycol groups. Propylene glycol alginate with any degree of esterification can be used in the composition of the present disclosure.

In some embodiments, the biopolymer comprises a pectin, such as CAS No. 9000-69-5, which is a galacturonic acid-rich carbohydrate. Pectins are complex polysaccharides of plant cell walls mainly including α-(1,4)-D-galacturonic acid units interrupted by the insertion of (1,2)-L-rhamnopyranosyl (rhamnose) residues. Some of the carboxylic groups are present in methyl ester form. Based on the degree of methyl esterification, pectins are classified as high-methoxyl (HM) pectins in which more than 50% of the carboxylic groups are in the methyl ester form, and low methoxyl (LM) pectins in which less than 50% of the groups are in the methyl ester forms. The major sources of commercial pectin are citrous wastes, apple pomace and sugar-beet pulp. Commercial pectin samples may contain a sugar or dextrose. Amidated pectins are those in which some of the carboxylic groups have been converted to amide groups by reaction with ammonia.

Pectins from any source and with any degree of esterification and/or amidation can be used in the compositions of the present disclosure. In some embodiments, the degree of esterification of the pectin is less than about 70%, less than about 60%, less than about 50%, less than about 40%, less than about 30%, less than about 20%, or less than about 10%.

In some embodiments, the biopolymer may be a gellan gum. An example of a commercially available gellan gum is CAS No. 71010-52-1, which is a microbial polysaccharide produced by Sphyngomonas elodea. Gellan gum is composed of tetra-saccharides repeating units of (1,3)-β-D-glucose, (1,4)-β-D-glucuronic acid, (1,4)-β-D-glucose and (1,4)-α-L-rhamnose units containing one carboxylate side group. According to the degree of acetylation at C-2 and C-6 positions of the (1,3)-β-D-glucose unit, the gellan gum can be divided into high acyl (HA) gellan gum and low acyl (LA) gellan gum. Gellan with any degree of acetylation can be used in the compositions of the present disclosure.

In some embodiments, the biopolymer is an alginate. Alginates are the salts of alginic acid, a polysaccharide naturally present in brown seaweeds/algae (Phaeophyceae) where they are found in the form of sodium, calcium and magnesium salts of alginic acid. They can also be synthesized by certain soil bacteria such as Pseudomonas and Azobacter. They are linear block copolymers of β-D-mannuronate (M) and α-L-guluronate (G) monomers linked by a 1,4-glycosidic bond. The blocks are either built up homogeneously with only guluronate, GG blocks, only mannuronate, MM blocks, or heterogeneous alternating blocks, GM blocks as illustrated on page 19 of the reference Handbook of Food Structure Development edited by Fotis Spyropoulos, Aris Lazidis and Jan Norton, Royal Society of Chemistry (2020), the contents of which are incorporated into the present application in their entirety. An example of a commercially available sodium alginate is CAS No. 9005-38-3, which is a common alginate salt used by the food industry. It is classified as a GRAS (generally regarded as safe) substance by the US Food and Drug Administration (FDA). The alginate used in the composition of the present disclosure can be derived from any sea-weed species, such as Fucus, Laminaria, Ascophyllum and Macrocystis or be produced by bacteria.

Alginates may form transparent and flexible coatings, which are readily soluble in water. The water solubility of a sodium alginate coating, for example, can be suppressed by addition of calcium or other divalent salts. The addition of divalent cations to an alginate induces conformational changes, such as alignment of the guluronic acid units and their zipping through cross-linking by calcium in an “egg-box” conformation, as illustrated on page 19 of the reference Handbook of Food Structure Development edited by Fotis Spyropoulos, Aris Lazidis and Jan Norton, Royal Society of Chemistry (2020). As a result of the crosslinking, the coating loses its ability to swell in the presence of water and retains its strength at high relative humidity values. Without being limited by theory, the “egg-box” conformation may impart the resistance to flow of liquids and semisolids, such as grease.

In some embodiments, the solution comprises at least about 0.05 wt. % of the biopolymer. In some embodiments, the solution comprises less than about 25 wt. % of the biopolymer. For example, the solution may comprise from about 0.05 wt. % to about 20 wt. %, from about 0.05 wt. % to about 15 wt. %, from about 0.05 wt. % to about 10 wt. %, from about 0.05 wt. % to about 5 wt. %, about 1 wt. % to about 25 wt. %, about 1 wt. % to about 20 wt. %, about 1 wt. % to about 15 wt. %, about 1 wt. % to about 10 wt. %, about 1 wt. % to about 5 wt. %, about 5 wt. % to about 25 wt. %, about 10 wt. % to about 25 wt. %, about 15 wt. % to about 25 wt. %, or about 20 wt. % to about 25 wt. % of the biopolymer. In some embodiments, the solution comprises about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, or about 25 wt. % of biopolymer.

In some embodiments, the formulation and/or solution comprise other components, such as starch. For example, the formulation and/or solution may comprise less than about 30 wt. % of starch. In some embodiments, the formulation and/or solution exclude starch. In some embodiments, the formulation and/or solution comprise from about 0.5 wt. % to about 30 wt. % of the starch, such as from about 1 wt. % to about 25 wt. %, about 1 wt. % to about 20 wt. %, about 1 wt. % to about 15 wt. %, about 1 wt. % to about 10 wt. %, or about 1 wt. % to about 5 wt. % of the starch.

Equipment used to apply the formulation and/or the solution, such as the size press or a flexographic printing machine, call for solutions having certain viscosities. Starch may be added to the solution and/or formulation to modify the viscosity. Additionally, in some embodiments, starch may provide an unexpected result when added to the formulation. For example, in certain circumstances, if a metal cation is added to the substrate without starch, the metal cation may sink into the paper whereas starch, having beneficial film-forming properties, would help keep the metal salt on the surface of the treated substrate so it may subsequently react with the biopolymer.

Formulations and solutions of the composition of the disclosure may be prepared in various ways without any limitation. For example, the components of a formulation or solution can be simply mixed together and further diluted with an aqueous solution or added separately to the aqueous solution in any order or simultaneously. If necessary, solutions and/or formulations can be heated to solubilize the components and/or obtain homogeneous mixtures. Finally, the resulting mixtures can be further diluted with water to obtain formulations and solutions containing the components at the required concentration. Starch supplied in powder form can be precooked and only afterwards combined with the solution containing the biopolymer, the metal salts and/or other additives. The solution containing the biopolymer can be obtained by adding the required biopolymer amount gradually into the aqueous solution under stirring. Stirring with or without heating is prolonged until a uniform gel is obtained. The prepared biopolymer solution can be blended with the cooked starch and/or additives as required.

The method of adding the solution comprising the biopolymer to the treated substrate is not particularly limited. In some embodiments, the solution may be sprayed and/or printed onto the treated substrate, which may already comprise the metal cation. The solution may be added at the wet end, press section, dryer section, and/or calendaring section of the paper machine. Additionally or alternatively, the solution may be applied before or after any of the foregoing sections, such as after a headbox in the wet end but before the press section. In some embodiments, the solution is added at the size press. Once added, the biopolymer may interact with metal cation to form a coating on the surface of the treated substrate (i.e., form the coated substrate). In some embodiments, the biopolymer is crosslinked with the metal cation.

Additional methods for application include, but are not limited to, applying the formulation at the size press and applying the solution at a coating unit, spraying the formulation at the wet end and applying the solution at the following size press, applying the formulation and/or solution at any location using any printing device, such as an inkjet printer or a flexographic printing press, or applying the formulation to the process water, such as in a pulp slurry, and applying the solution at a downstream location by spraying and/or printing.

In some embodiments, the coated substrate comprises at least about 0.01 wt. % of the biopolymer. In some embodiments, the coated substrate comprises less than about 15 wt. % of the biopolymer. For example, the coated substrate may comprise from about 0.5 wt. % to about 12 wt. %, from about 1 wt. % to about 10 wt. %, or from about 3 wt. % to about 7 wt. % of the biopolymer. In some embodiments, the coated substrate comprises about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, or about 15 wt. % of the biopolymer.

Those skilled in the art will recognize that the amount of biopolymer present on the coated substrate may be quantified by g/m². The conversion between wt. % and g/m² is disclosed as Formula 1. In some embodiments, the biopolymer may be present in the solution in an amount such as to provide a coated substrate comprising from about 0.006 g/m²to about 16 g/m², such as from about 0.01 g/m² to about 14 g/m², about 0.05 g/m² to about 12 g/m², about 0.1 g/m² to about 8 g/m², about 0.5 g/m² to about 6 g/m², or about 1 g/m² to about 3 g/m².

In some embodiments, the substrate, treated substrate, and/or coated substrate comprises multiple sides and/or multiple surfaces. For example, any of the substrates, such as the coated substrate, may comprise a first side and a second side. In certain embodiments, the biopolymer may be present in the solution in an amount such as to provide a coated substrate comprising from about 0.006 g/m² to about 8 g/m² of the biopolymer on the first side and from about 0.006 g/m² to about 8 g/m² of the biopolymer on the second side based on dry weight. For example, the biopolymer may be present in the solution in an amount such as to provide a coated substrate comprising from about 0.01 g/m² to about 7 g/m², about 0.011 g/m² to about 6 g/m², about 0.012 g/m² to about 5 g/m², about 0.05 g/m² to about 5 g/m², about 0.1 g/m² to about 5 g/m², or about 1 g/m² to about 5 g/m² of the biopolymer on each of the first and second sides based on dry weight.

In some embodiments, if starch is added to the substrate and/or treated substrate, the treated substrate and/or coated substrate may comprise from about 0.5 wt. % to about 18 wt. % of the starch. For example, the treated substrate and/or coated substrate may comprise from about 1 wt. % to about 15 wt. %, from about 1 wt. % to about 10 wt. %, or from about 1 wt. % to about 5 wt. % of the starch. In some embodiments, the treated substrate and/or coated substrate may comprise about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, or about 18 wt. % of the starch.

The amount of applied starch may be quantified as g/m². In some embodiments, the starch may be present in the formulation and/or solution in an amount such as to provide a treated substrate and/or coated substrate comprising from about 0.01 g/m² to about 24 g/m² of starch based on dry weight. For example, the starch may be present in the formulation and/or solution in an amount such as to provide a treated substrate and/or coated substrate comprising from about 0.02 g/m² to about 22 g/m², about 0.05 g/m² to about 20 g/m², from about 0.1 g/m² to about 15 g/m², from about 0.5 g/m² to about 12 g/m², from about 1 g/m² to about 8 g/m², or from about 3 g/m² to about 6 g/m².

In some embodiments, the substrate and/or treated substrate comprises multiple sides. For example, the substrate and/or treated substrate may comprise a first side and a second side. In certain embodiments, the starch may be present in the solution and/or formulation in an amount such as to provide a treated substrate and/or coated substrate comprising from about 0.01 g/m² to about 10 g/m², about 0.01 g/m² to about 8 g/m², about 0.1 g/m² to about 8 g/m², about 0.5 g/m² to about 8 g/m², about 1 g/m² to about 8 g/m², or about 4 g/m² to about 8 g/m² of starch on each of the first and second sides based on dry weight.

Once the solution is applied to the treated substrate, the biopolymer reacts with the metal cation to form a barrier/coating.

In some embodiments, a substrate is coated with a formulation comprising, consisting of, or consisting essentially of a calcium salt. The substrate may optionally be dried. Then, a solution comprising, consisting of, or consisting essentially of an alginate is added to the treated substrate. Starch may optionally be present in the formulation and/or solution.

The present disclosure also provides coated substrates including a substrate comprising the reaction product of any biopolymer disclosed in or contemplated by the present disclosure and a metal cation disclosed in or contemplated by the present disclosure. The substrate may be a fibrous material containing about 9 wt. % or less, about 8 wt. % or less, about 7 wt. % or less, about 6 wt. % or less, about 5 wt. % or less, about 4 wt. % or less, about 3 wt. % or less, about 2 wt. % or less, or about 1 wt. % or less of a filler. In some embodiments, the substrate excludes a filler. The substrate may be, for example kraft paper or a molded paper product capable of containing a food product or beverage product.

The present disclosure also provides products, such as coated substrates, produced by any of the methods disclosed herein. For example, the disclosure provides a coated substrate produced by the process of applying a formulation comprising a metal cation to a surface of a substrate to form a treated substrate, adding a solution comprising a biopolymer to the treated substrate, and allowing the biopolymer and the metal cation to react to form a coated substrate.

The ability of the coated substrate to resist grease can be defined in terms of a kit value. In some embodiments, the coated substrate of the present disclosure comprises a kit value of at least 5, such as 5.5, 6, 6.5, 7, 7.5, 8, 8.5, 9, 9.5, or higher. A kit value may be obtained using the TAPPI T 559 pm-96 test method (KIT Test).

The foregoing may be better understood by reference to the following examples, which are intended for illustrative purposes and are not intended to limit the scope of the disclosure or its application in any way.

### EXAMPLES

Several laboratory experiments were conducted to measure the ability of the compositions disclosed herein to confer barrier properties to paper and paperboard substrates. Formulations including metal cations and solutions including biopolymers were applied on the substrate using a K Hand Coater from RK PrintCoat Instruments Ltd., provided with wire-wound Meyer rods of different sizes. Soultions and/or formulations containing starch were applied with Meyer rods producing a wet film thickness of about 12 or about 40 microns, whereas coating solutions containing only the biopolymer were applied using a rod producing a wet film thickness of about 40 microns. The substrate was weighed before and after application of the coating to determine the wet pick-up. Based on this value and the dry solids of the coating solutions and/or formulations, the dry coat weight applied on the substrate was determined.

The treated substrate was dried at about 90° C. using a drum dryer and coated another time using the same procedure for substrates coated with two coating layers (i.e., applying a formulation including a metal cation then applying a solution including a biopolymer). After drying, single and double coated substrates were conditioned for at least about 12 hours at about 23° C. and about 50% relative humidity (RH) before measuring their barrier properties.

In some examples, starch was used in the solutions and formulations. When supplied as a liquid starch, it was diluted with deionized water to the required concentration. Starch supplied in powder form was cooked at about 20 weight % in deionized water (e.g., 20 g of starch in a total 100 g of liquid mixture) at about 95° C. for about 30 minutes. The cooked starch was further diluted with deionized water when a lower starch concentration was required. Starch containing solutions and formulations were kept in a water bath at about 60° C. before being applied to the substrate and/or treated substrate.

Biopolymer solutions at about 2 or about 4 wt. % were prepared by adding the required biopolymer dry solids gradually into deionized water under stirring at about 700 rpm. Stirring continued until a uniform gel was obtained (e.g., for about 3 hours).

Grease resistance was measured according to TAPPI T 559 pm-96 test method (KIT Test). This test uses a series of 12 “KIT” solutions, labelled 1-12, containing variable amounts of corn oil, heptane and toluene, with solution 12 being the most aggressive and solution 1 being the least aggressive. The test involves releasing a drop of a selected KIT solution onto the substrate and observing after 15 seconds any darkening of the underlying area, which implies failure of the test. The sample score is the highest number of KIT solutions applied without failure. This is reported as the Kit value for the substrate. Kit values were determined on two samples per conditions, with four tests per samples. The individual test values were then averaged.

Permeability, also referred to as “porosity,” was measured using an L&W Bendtsen tester (code SE 114), equipped with a 10 cm² measuring head. The higher the reduction of permeability/porosity, the higher the capability of the coating to seal the sheet. Eight measurements per sheet were performed in total and a minimum of three samples were analyzed. Measurements were carried out at a standard pressure of about 1.47±0.02 kPa according to the ISO 5636 method.

WVTR was measured gravimetrically according to the TAPPI T 448 om-97 test method. Anhydrous calcium chloride was placed in a water vapor permeability cup, EZ-cup Vapometer, supplied by Thwing-Albert Instrument Company. The cup was sealed with the sample with its coated side facing the 23° C., 50% RH environment and the opposite side facing the desiccant. The change of weight over time was recorded to determine WVTR expressed as grams of water vapor penetrating one square meter area of the sample in one day.

### Example 1

A sandwich-wrap kraft paper of about 40 g/m² basis weight was coated in a first step with aqueous formulations containing starch and calcium chloride using a Meyer rod providing a wet-film thickness of about 12 microns. The starch used was Redifilm 5400, a liquid starch from Ingredion. Three coating formulations were prepared containing variable concentrations of starch (10, 15 and 20%) and a fixed amount of calcium chloride to provide an amount of calcium chloride of about 0.5% based on dry paper weight. After application of these coating formulations, the paper was dried. A solution of about 2 wt. % sodium alginate was applied in a second step using a Meyer rod providing a wet-film thickness of about 40 microns. The sodium alginate used was Vivapur FD150 from J. Rettenmaier & Söhne Group (JRS). The obtained coated papers were dried again after application of this second layer. As a control, paper was coated with formulations that did not contain calcium chloride but all other experimental conditions were the same.

As shown by the data in Table 1, pretreatment of paper with calcium (A1, A2, A3) led to a significant increase of the grease resistance (KIT value) provided by starch and alginate only (1B, 2B, 3B). A person having ordinary skill in the art will recognize that amounts may be measured several different ways, and in particular to the papermaking industry, g/m² may be used.

The conversion between wt. % and g/m² is as follows:

$$\begin{matrix}\left[\text{component applied to paper} \left({\text{g} / \text{m}}^{2}\right)\right] = \\ \left[\text{component applied to paper} \left(\text{wt} \text{. \%}\right)\right] \times \\ \left[\text{basis weight of paper} \left({\text{g} / \text{m}}^{2}\right)\right] / 100\end{matrix} \qquad \text{(Formula 1)}$$

where the weight percent of a component applied to paper is determined based on the dry weight of the finished dried paper.

WVTR was measured for coated papers A2, A3, B2 and B3. The data obtained are summarized in Table 1. A reduction of WVTR was found for papers coated with alginate and pretreated with the calcium salt (A2 and A3) compared to paper with no calcium salt pretreatment (B2 and B3).

Additional experiments were run (C1, C2, and C3) using amounts of starch, calcium chloride and alginate as for B1, B2, B3, but inverting the order of addition of the components, coating the sheets first with alginate and in a second step with starch/calcium chloride. Grease resistance of the sheets coated with alginate first and in a second step with starch/calcium chloride (C1, C2, and C3) was less than for sheets coated first with starch/calcium chloride and in a second step with alginate (B1, B2, and B3). Coating of the sheet with alginate alone (D) did not provide significant grease resistance.

TABLE 1

| Composition | 1st coating | 1st Coating Weight, g/m² | 2nd coating | 2nd Coating weight, g/m² | KIT VALUE | WVTR, g/m²/d |
|---|---|---|---|---|---|---|
| A1 | starch/CaCl₂ | 1.4 | sodium alginate | 0.67 | 7.5 | - |
| A2 | starch/CaCl₂ | 1.8 | sodium alginate | 0.67 | 8.3 | 358 |
| A3 | starch/CaCl₂ | 2.6 | sodium alginate | 0.66 | 9.3 | 345 |
| B1 | starch | 1.3 | sodium alginate | 0.68 | 1.8 | - |
| B2 | starch | 1.8 | sodium alginate | 0.67 | 2 | 382 |
| B3 | starch | 2.5 | sodium alginate | 0.64 | 3.3 | 375 |
| C1 | sodium alginate | 0.61 | starch/CaCl₂ | 1.3 | 1.3 | - |
| C2 | sodium alginate | 0.69 | starch/CaCl₂ | 1.7 | 2.3 | - |
| C3 | sodium alginate | 0.62 | starch/CaCl₂ | 2.6 | 3 | - |
| D | sodium alginate | 0.67 | - | - | 1 | - |

### Example 2

The same sandwich-wrap kraft paper used in Example 1 was coated in a first step with an aqueous formulation containing about 15 wt. % of starch together with a salt, calcium acetate or calcium lactate, using a Meyer rod providing a wet-film thickness of about 12 microns. The calcium salts in the formulation were at concentrations such as to provide an amount of the calcium salt of about 0.5 wt. % based on dry paper weight. The starch used was Redifilm 5400. In a second step, after drying the sheet, a solution of about 2 wt. % sodium alginate (Vivapur FD 150) was applied using a Meyer rod providing a wet-film thickness of about 40 microns. The obtained coated papers were dried again after application of the second layer.

As shown in Table 2 with both coating formulations, E and F, a good barrier for grease resistance was obtained. A higher KIT value was obtained when the calcium salt was calcium acetate compared to calcium lactate.

TABLE 2

| Composition | 1st coating | 1st Coating Weight, g/m² | 2nd coating | 2nd Coating weight, g/m² | KIT VALUE |
|---|---|---|---|---|---|
| E | starch/Ca Ac | 2.2 | sodium alginate | 0.68 | 7.8 |
| F | starch/Ca lactate | 2 | sodium alginate | 0.6 | 4.6 |

### Example 3

The same sandwich-wrap kraft paper of Example 1 was coated in a first step with aqueous formulations containing about 10 wt. % starch and calcium chloride at a concentration selected to provide an amount of calcium chloride on paper of about 0.5 wt. % based on dry paper weight. This formulation was applied on paper using a Meyer rod providing a wet-film thickness of about 12 microns. After being dried, the paper was coated with a formulation containing about 8 wt. % of starch and about 2 wt. % of sodium alginate. This second coating was also applied with the same rod providing a wet-film thickness of about 12 microns. Another sample was coated using similar conditions, but without calcium chloride in the first coating layer. The starch used for both layers was Redifilm 5400 and sodium alginate was Vivapur FD150.

As shown by the data in Table 3, higher grease resistance was obtained by including calcium chloride in the first coating layer of about 40 g/m² of kraft paper.

TABLE 3

| Composition | 1st coating | 1st Coating Weight, g/m² | 2nd coating | 2nd Coating weight, g/m² | KIT VALUE |
|---|---|---|---|---|---|
| G | starch/CaCl₂ | 1.4 | starch/sodium alginate | 1.5 | 9.3 |
| H | starch | 1.3 | starch/sodium alginate | 1.2 | 7.5 |

### Example 4

A kraft linerboard with a basis weight of about 130 g/m² containing about 7 wt. % of calcium carbonate was coated with starch or starch/calcium chloride using a Meyer rod providing a wet-film thickness of about 40 microns. The starch was Stabilys Evo 280 from Roquette supplied in powder form. The concentration of this starch was about 10 wt. % in the coating formulations. The concentration of calcium chloride in the coating formulation was selected such as to provide an amount of calcium chloride on the linerboard of about 0.5 wt. % based on dry linerboard weight.

After being dried, the linerboard was coated with a solution of about 2 wt. % of sodium alginate using a Meyer rod providing a wet-film thickness of about 40 microns. The sodium alginate used was Vivapur FD150. Linerboard was also coated with a single layer of starch or a single layer of starch/calcium chloride using the same amounts of these additives as for the first coating layer of the double coated linerboard samples.

As shown in Table 4, starch applied as a single layer with (J) or without (L) calcium chloride provided no grease resistance. Some grease resistance was obtained by coating alginate on the top of starch (K). A significant improvement of grease resistance was obtained by adding calcium chloride to starch in the first coating layer, followed by alginate in the second coating layer (I). Sodium alginate alone applied in a single layer provided practically no grease resistance (M). In Table 4, the values of permeability/porosity of the coated sheets are reported as well. The linerboard with no coating applied had a permeability/porosity of about 655 mL/min. Coating compositions I, K, and M reduced all permeability/porosity of the linerboard to a similar low level.

Based on the low permeability/porosity value obtained by coating the sheet with alginate only (M), one of ordinary skill in the art would have expected that a coating with alginate only, based on its sealing capability, would also provide a barrier for grease penetration. This was not the case. Surprisingly, only the composition of the presently claimed invention (I) provided a significant increase in grease resistance.

TABLE 4

| Composition | 1st coating | 1st Coating Weight, g/m² | 2nd coating | 2nd Coating weight, g/m² | KIT VALUE | Permeability, mL/min |
|---|---|---|---|---|---|---|
| 1 | starch/CaCl₂ | 4.8 | sodium alginate | 0.80 | 4.5 | 66 |
| J | starch/CaCl₂ | 4.5 | - | - | 0 | 491 |
| K | starch | 4.4 | sodium alginate | 0.82 | 2.3 | 71 |
| L | starch | 4.3 | - | - | 0 | 468 |
| M | sodium alginate | 0.76 | - | - | 0.8 | 70 |

### Example 5

An uncoated wood-free paper with a basis weight of about 82 g/m² containing about 22 wt. % of calcium carbonate was coated with various formulations and/or solutions. Starch-containing coating formulations contained starch (Redifilm 5400) at a concentration of about 15 wt. %. These formulations were applied using a Meyer rod providing a wet-film thickness of about 12 microns. Alginate (Vivapur FD150) was applied at about 2 wt. % using a Meyer rod providing a wet-film thickness of about 40 microns. The calcium chloride concentration was adjusted to provide an amount of calcium chloride of about 0.5 wt. % based on dry paper weight.

No grease resistance was obtained for the paper coated with a single layer of alginate (Q). Following application of a second coating having starch/calcium chloride (P), no grease resistance was obtained as well. A significant improvement of grease resistance could only be obtained by coating the paper first with starch/calcium chloride and then by coating it with alginate in a second step (N). This coated paper had also the lowest permeability. The paper coated with a single layer of starch/calcium chloride had limited grease resistance (O).

TABLE 5

| Composition | 1st coating | 1st Coating Weight, g/m² | 2nd coating | 2nd Coating weight, g/m² | KIT VALUE | Permeability, mL/min |
|---|---|---|---|---|---|---|
| N | starch/CaCl₂ | 2.4 | sodium alginate | 0.64 | 3.8 | 1.3 |
| O | starch/CaCl₂ | 2.5 | - | - | 1 | 12.5 |
| P | sodium alginate | 0.75 | starch/CaCl₂ | 2.3 | 0 | 17.3 |
| Q | sodium alginate | 0.69 | - | - | 0 | 464 |

### Example 6

The same sandwich-wrap kraft paper of Example 1 was coated in a first step with an aqueous formulation containing about 15 wt. % starch (Redifilm 5400) or a formulation containing the same starch at about 15 wt. % and calcium acetate. The concentration of calcium acetate was selected to provide an amount of calcium acetate on paper corresponding to about 0.5 wt. % based on dry paper weight. The two formulations were applied on paper using a Meyer rod providing a wet-film thickness of about 12 microns. After being dried, the papers were coated with a solution of about 2 wt. % of pectin using a Meyer rod providing a wet-film thickness of about 40 microns. The pectin used was pectin from citrus peel containing ≥ 74% of galacturonic acid (supplier Sigma-Aldrich). As shown in Table 6, the paper containing the calcium salt in the first coating layer (R) had significantly higher grease resistance than the paper containing no calcium salt (S).

TABLE 6

| Composition | 1st coating | 1st Coating Weight, g/m² | 2nd coating | 2nd Coating weight, g/m² | KIT VALUE |
|---|---|---|---|---|---|
| R | starch/Ca Ac | 2.1 | pectin | 0.65 | 10 |
| S | starch | 1.8 | pectin | 0.63 | 4.5 |

### Example 7

The same sandwich wrap paper of Example 1 was coated with starch or starch/calcium chloride using a Meyer rod providing a wet-film thickness of about 12 microns. The formulations contained about 15 wt. % of starch (Stabilys EVO 280). In a second step, after being dried, the papers were coated with a solution containing about 2 wt. % of pectin using a Meyer rod providing a wet-film thickness of about 40 microns. The pectin used was pectin from citrus peel containing ≥ 74% of galacturonic acid (supplier Sigma-Aldrich). As shown in Table 7, pretreatment of the sheet with the calcium salt (T) boosted grease resistant performance compared to the sheet that did not contain calcium (U).

TABLE 7

| Composition | 1st coating | 1st Coating Weight, g/m² | 2nd coating | 2nd Coating weight, g/m² | KIT VALUE |
|---|---|---|---|---|---|
| T | starch/CaCl₂ | 2.0 | pectin | 0.65 | 5.3 |
| U | starch | 1.8 | pectin | 0.65 | 1.3 |

### Example 8

The same sandwich-wrap kraft paper of Example 1 was coated in a first step with aqueous formulations containing only calcium chloride with a Meyer rod providing a wet-film thickness of about 12 microns. Three coating formulations were prepared containing calcium chloride at three different levels to provide an amount of calcium chloride of about 0.5, 3 and 7 wt. % based on dry paper weight. After application of these coating formulations, the paper was dried. A solution of about 2 wt. % sodium alginate was applied in a second step using a Meyer rod providing a wet-film thickness of about 40 microns. As shown by the data in Table 8, no grease resistance was obtained when the paper was pretreated with 0.5 wt. % calcium chloride (V1). The addition of 3 wt. % of calcium chloride to paper provided some grease resistance (V2). Greater grease resistance was obtained by adding 7 wt. % calcium chloride (V3).

TABLE 8

| Composition | 1st coating | 1st Coating Weight, g/m² | 2nd coating | 2nd Coating weight, g/m² | KIT VALUE |
|---|---|---|---|---|---|
| V1 | CaCl₂ | 0.3 | sodium alginate | 0.73 | 0 |
| V2 | CaCl₂ | 1.7 | sodium alginate | 0.68 | 2.3 |
| V3 | CaCl₂ | 4.1 | sodium alginate | 0.75 | 5 |

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a metal cation” is intended to include “at least one metal cation” or “one or more metal cations.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition, formulation and/or solution disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5% of the cited value.

In accordance with the present disclosure, the terms “apply,” “applying,” “applied,” and the like may be used interchangeably with the terms, “add,” “adding,” “added,” and the like. For example, “applying” a formulation comprising a metal cation to a surface of the substrate could be viewed as equivalent to “adding” a formulation comprising a metal cation to a surface of the substrate.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of coating a substrate, comprising:
applying a formulation comprising a metal cation to a surface of the substrate to form a treated substrate,
adding a solution comprising a biopolymer to the treated substrate, and
allowing the biopolymer and the metal cation to react to form a coated substrate.

2. The method of claim 1, wherein the substrate comprises a fibrous material and/or wherein the coated substrate comprises a fibrous material.

3. The method of claim 2, wherein the fibrous material comprises about 9 wt. % or less of a filler.

4. The method of claim 2, wherein the fibrous material is a kraft paper or a molded paper product.

5. The method of claim 1, wherein the substrate excludes a filler and/or wherein the coated substrate excludes a filler.

6. The method of claim 1, wherein the formulation comprising the metal cation forms a first layer on a surface of the treated substrate.

7. The method of claim 6, wherein the first layer covers about 75% to about 100% of the surface of the treated substrate.

8. The method of claim 1, wherein the formulation comprising the metal cation further comprises starch and/or wherein the solution comprising the biopolymer further comprises starch.

9. The method of claim 1, further comprising drying the treated substrate before adding the solution comprising the biopolymer.

10. The method of claim 1, wherein the formulation comprising the metal cation is sprayed or printed onto the surface of the substrate and/or wherein the solution comprising the biopolymer is sprayed or printed onto the surface of the treated substrate.

11. The method of claim 1, wherein the formulation comprising the metal cation is applied to the substrate at a size press or in a wet end of a papermaking machine.

12. The method of claim 1, wherein the solution comprising the biopolymer is added to the treated substrate at a size press.

13. The method of claim 1, wherein the biopolymer comprises a carboxylic acid group.

14. The method of claim 1, wherein the metal cation is selected from the group consisting of calcium, magnesium, zinc, barium, copper, strontium, manganese, iron, nickel, cobalt, tin, cadmium, lead, and any combination thereof.

15. The method of claim 1, wherein the biopolymer is selected from the group consisting of an alginate, a pectin, a gellan gum, and any combination thereof.

16. A coated substrate, comprising:
a reaction product of a biopolymer and a metal cation, wherein the reaction product is disposed on a surface of the coated substrate, further wherein the coated substrate comprises a fibrous material comprising 8 wt. % or less of a filler.

17. The coated substrate of claim 16, further comprising from about 0.01 wt. % to about 2.5 wt. % of the metal cation.

18. The coated substrate of claim 16, further comprising from about 0.01 wt. % to about 12 wt. % of the biopolymer.

19. The coated substrate of claim 16, wherein the coated substrate has a kit value of at least about 5.

20. A method of coating a substrate, comprising:
applying a formulation comprising a metal cation to a surface of the substrate to form a treated substrate,
contacting the formulation with a solution comprising a biopolymer, and
allowing the biopolymer and the metal cation to react to form a coated substrate, wherein the coated substrate comprises less than about 8 wt. % of the metal cation.
